(19) United States
(12) Patent Application Publication
(10) Pub. No.: US 2009/0177693 A1
(43) Pub. Date: Jul. 9, 2009

(54) Electronic Device Driven Selection and Retrieval of Media Files from Media Source

(75) Inventor: Nae Kwon JUNG, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: EMTRACE TECHNOLOGIES, INC., Seoul (KR)

(21) Appl. No.: 11/969,392

(22) Filed: Jan. 4, 2008

(51) Int. Cl. G06F 17/30

(52) U.S. Cl. 707/104.1; 707/E17.009

(57) ABSTRACT

An electronic device automatically selects a subset of media files to retrieve from a media source based on a list of the media files received from the media source. The list of media files indicates the media files that are stored in the media source and are retrievable by the electronic device. The electronic device includes an algorithm implementing a scheme to automatically select and retrieve the media files based on the list of media files received from the media source. A user of the electronic device is relieved of the task of selecting the media files to be stored on the electronic device because the electronic device automatically selects and retrieves the media files. Further, the media source need not include codes or implementations to select the media files for retrieval by the electronic device because the electronic device is responsible for selecting the media files for retrieval.

### BACKGROUND OF THE INVENTION

1. Field of the Invention

The present invention relates to selecting media files to be retrieved from a media source for access on an electronic device and, more specifically, to automatically selecting the media files for retrieval by the electronic device.

2. Description of the Related Art

Electronic devices such as electronic picture frames and desktop widget devices have limited storage capacity compared to media sources such as desktop computers or storage devices (e.g., hard disk). The electronic picture frames, for example, have storage capacity in the range of megabytes whereas the media sources have storage capacity often in the range of gigabytes. Therefore, users of the electronic devices generally transfer a selected number of media files from the media sources onto the electronic device for access on the electronic device. When the users want to access different media files, a new set of media files are transferred from the media source to the electronic devices.

Generally, the media files to be transferred from the media source to the electronic device are selected manually by the user using the user input devices associated with the media sources. Specifically, the user manually selects the media files to be transferred from the media sources to the electronic device by selecting the media files using user interfaces that control the operation of the media sources. For this purpose, the media sources often include designated programs (e.g., iTunes) that allow the users to select the media files for transfer.

Manually selecting the media files, however, is often an inconvenient and time-consuming process. In some cases, the user does not have a predetermined preference for one media file over another, and may want the media files to be selected and updated automatically by the electronic device. In electronic picture frames, for example, the user may not want to spend much time selecting and updating the pictures for viewing. When the pictures displayed on the electronic picture frame become stale, the user must link the electronic picture frames to the media source, select the media files for display on the electronic picture frame, and download the pictures to the electronic picture frame. Further, the user must use the user interface of the media source to select the media files to update the media files. Therefore, the overall process for updating the pictures is inconvenient and time-consuming to the user.

Further, conventional schemes for updating media files of the electronic devices requires codes or programs to be provided at the media sources. Therefore, in order for the electronic devices to receive the media files from multiple media sources, each media source must have codes or programs that allow the users to select the media files for transfer to the electronic devices. For example, picture images for an electronic picture frame may be retrieved from various sources such as personal computers, web-based services (e.g., Yahoo Flickr), CD-ROMs (Compact Disk read-only memory), DVDs (Digital Video Disc), portable hard drives, and DVRs (digital video recorders). In order for the user to update the media files from such diverse media sources, each media source must be implemented with mechanisms or tools to enable the user to select and transfer the media files. Providing the mechanisms or tools for such diverse types of media sources, however, may be impracticable or prohibitively expensive. Further, web service providers may refuse or decline to provide functions to support the electronic devices.

### SUMMARY OF THE INVENTION

Embodiments of the present invention include an electronic device or a method that automatically selects a subset of media files to retrieve from a media source based on a list of the media files received from the media source. The list of media files indicates the media files that are stored in the media source and are retrievable by the electronic device. The electronic device includes codes for executing an algorithm that automatically selects the media files for retrieval based on the list of media files received from the media source. A user of the electronic device is relieved of the task of selecting the media files to be stored on the electronic device because the algorithm executed on the electronic device automatically selects and retrieves the media files. Also, the user need not access the user interface of the media source to select the media files to be retrieved by the electronic device. Further, the media source need not include codes or implementations to select the media files for retrieval by the electronic device because the electronic device is responsible for selecting the media files for retrieval.

In one embodiment, the media files stored on the electronic device are updated during a communication session with the media source. The communication session may be prompted by a triggering event detected by the electronic device. The triggering event may be activation of the communication interface of the electronic device or the media source, the elapse of a predetermined amount of time, or a signal from the media source indicating updating of the media files stored in the media source.

In one embodiment, the media source sends time stamps of the media files indicating the time the media files were added to the media source. The electronic device uses the time stamps to select the media files that were recently added to the media source. The users of the electronic device generally prefer to access recently added media files over older media files. By using the time stamps to give priority to recently added media files, it is more likely that the media files of interest to the user are selected by the electronic device for retrieval.

The present invention can be implemented as a computer program product stored on a computer readable storage medium adapted to store a subset of the media files stored on a media source. Such computer program product may also be stored in a computer apparatus.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates an electronic device and a media source communicating with the electronic device, according to one embodiment of the present invention.

FIG. 2A illustrates the hardware system of the electronic device, according to one embodiment of the present invention.

FIG. 2B illustrates the software modules of the electronic device, according to one embodiment of the present invention.

FIG. 3A illustrates the hardware system of the media source, according to one embodiment of the present invention.

FIG. 3B illustrates the software modules of the media source, according to one embodiment of the present invention.

FIGS. 4A and 4B are flowcharts illustrating a method for updating the media files of the electronic device from the media source, according to one embodiment of the present invention.

FIGS. 5A to 5D are diagrams illustrating schemes for updating the media files of the electronic device from the media source, according to embodiments of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

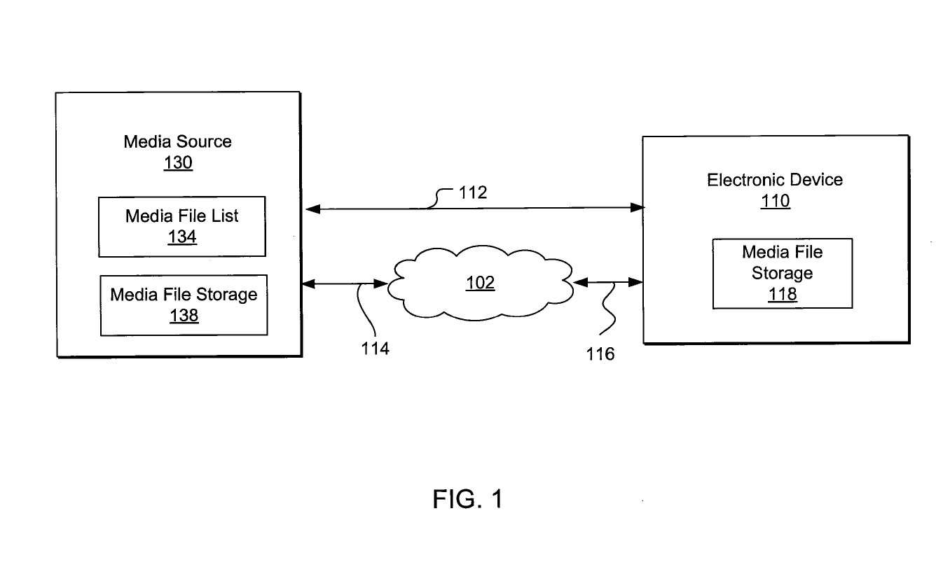

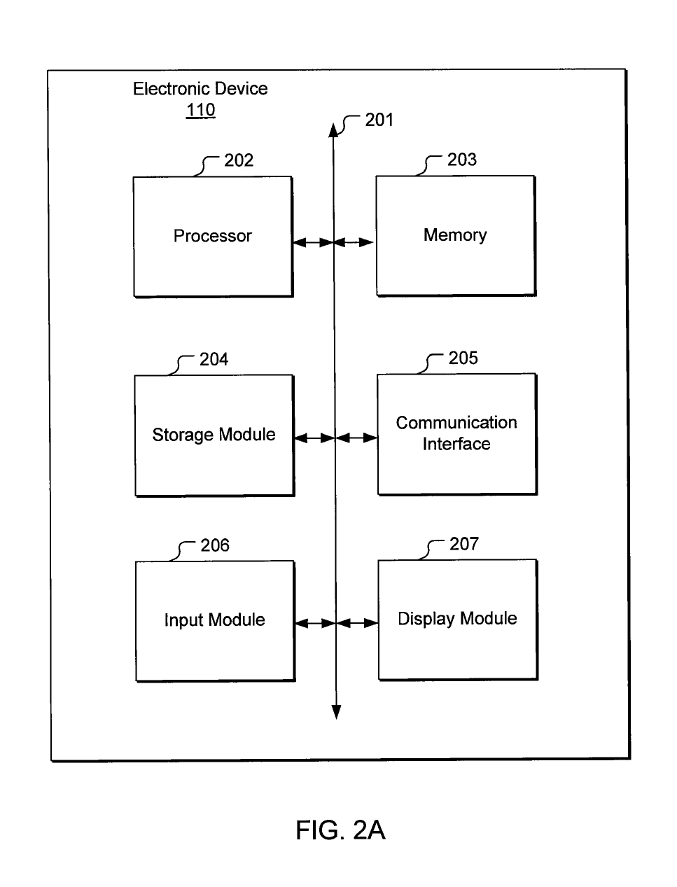

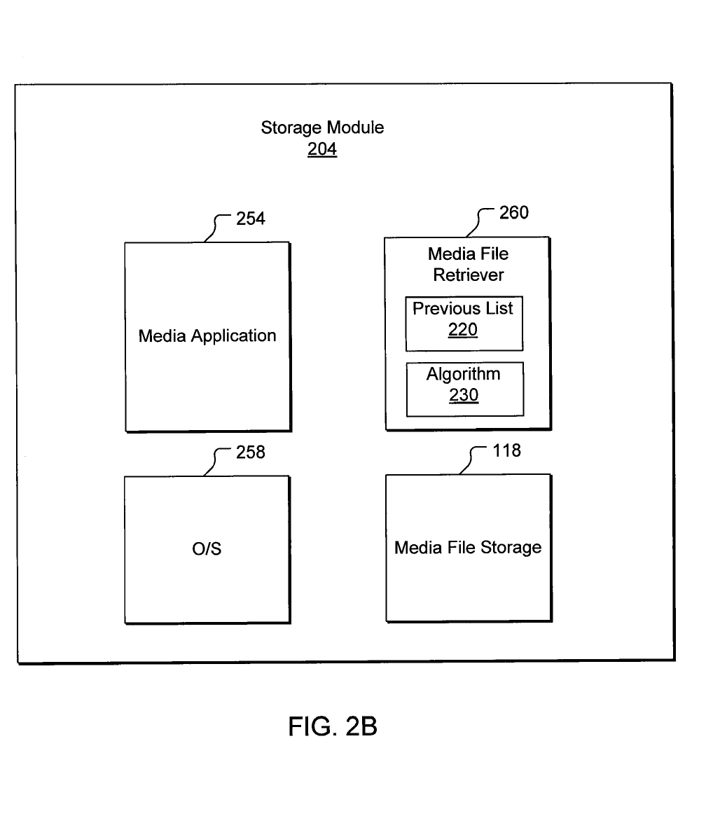

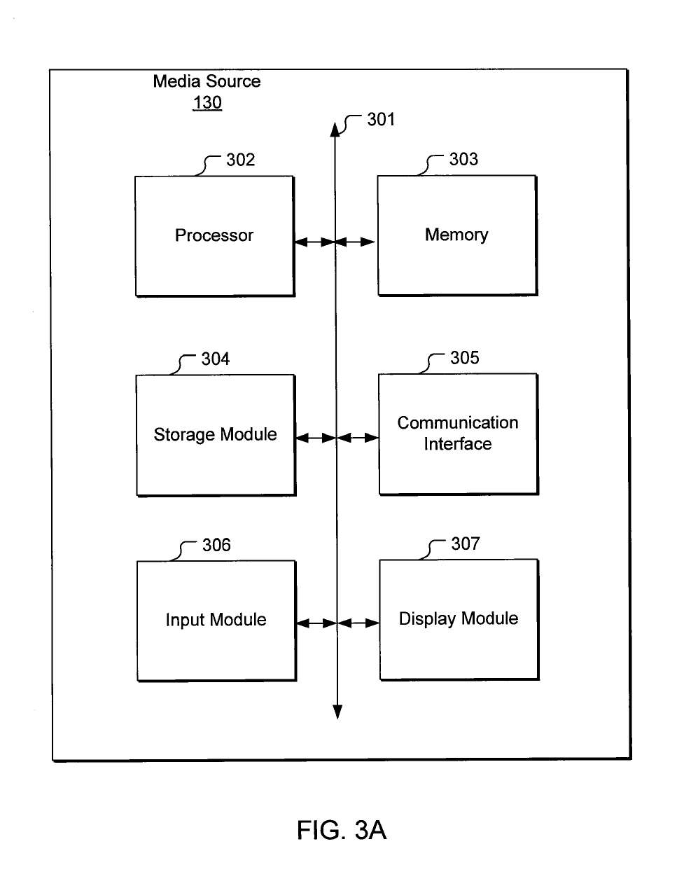

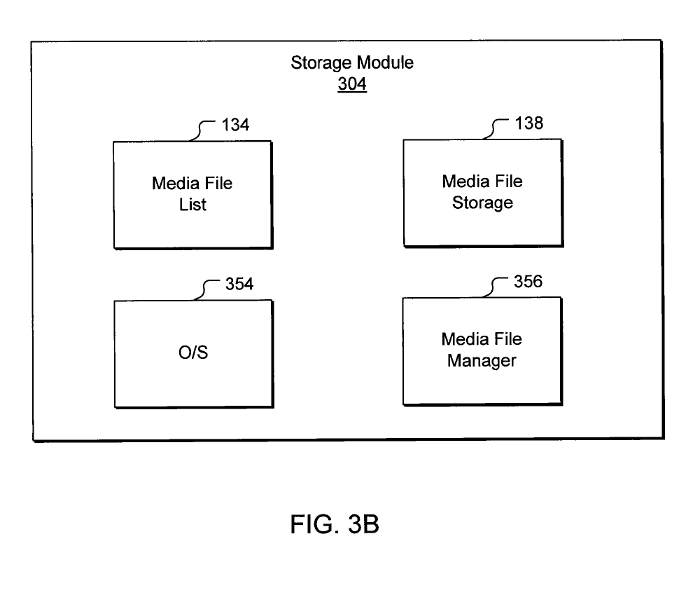

FIG. 1 illustrates an electronic device 110 for accessing media files, and a media source 130 storing media files for retrieval by the electronic device 110, according to one embodiment of the present invention. The media source 130 communicates with the electronic device 110 locally via a communication channel 112 or via a network 102 (e.g., the Internet) using communication channels 114, 116 coupled to the network 102. The communication channels 112, 114, 116 are established by communication interfaces of the electronic device 110 and the media source 130, as described below in detail with reference to FIGS. 2A and 3A.

The media source 130 is a computing device or a storage device capable of storing media files compatible with the electronic device 110. In one embodiment, the media source 130 stores the media files in media file storage 138. The media source 130 also generates and maintains a list of media files 134 stored in the media file storage 138. In one embodiment, the media source 130 may be a computing device or a storage device dedicated to serving the electronic device 110. In another embodiment, the media source 130 may be a general purpose computing device or storage device capable of performing other functions in addition to serving the electronic device 110. In still another embodiment, the media source 130 may be part of a web-based system implemented on two or more servers dispersed throughout a network (e.g., the Internet).

The media files may be various types of files that may be accessed by one or more media application programs. The media files include, among other files, image files, video sequence, and audio files (e.g., MP3 files).

The electronic device 110 is a device that retrieves media files from the media source 130 and allows users to access the retrieved media files. The electronic device 130 may be various devices such as an electronic picture frame, a desktop widget player, a PDA (Personal Digital Assistant), an MP3 player, a stand-alone multimedia player (e.g., Divx player), and a cellular phone. In one embodiment, the electronic device 110 is a stand-alone type desktop widget player such as “WidgetStation” created by Emtrace Technologies, Inc. of Seoul, South Korea. The electronic device 110 includes at least one module in the form of software, hardware, or a combination of both to allow the user of the electronic device 110 to access the media files. The electronic device also includes media file storage 118 for storing the media files retrieved from the media source 130.

FIG. 2A is a diagram illustrating the electronic device 110 having at least the functionalities of a basic computing device, and includes a processor 202, a memory 203, a storage module 204, a communication interface 205, an input module 206, and a display module 207. Not all components of the electronic device 110 are shown in FIG. 2A and certain components not necessary for illustration of the present invention (for example, audio speakers) are omitted herein. Each component of the electronic device 110 may be communicatively coupled through a bus 201. Each component of the electronic device 110, whether alone or in combination with other components, can be implemented for example, in software, hardware, firmware or any other combination thereof.

The processor 202 is a conventional processor or controller such as an ARM9 type processor or an Intel® XScale® processor. The memory 203 is conventional computing memory such as a random access memory (RAM). The storage module 204 is a conventional long term storage device, for example, a flash memory or a hard disk drive (e.g., magnetic hard drive). The storage module 204 typically stores conventional operating systems such as a Linux-based operating system, Garnet™ OS or Palm OS® from Access Co., Ltd., or Windows CE or Windows Mobile from Microsoft® Corporation and other software applications for use by the electronic device 104, as described in detail below with reference to FIG. 2B. The input module 206 can be a keyboard, a touch sensitive screen, or any other type of input device, and the display module 207 can be a liquid crystal display (LCD) device or any other type of display device. In one example, the display module 207 is a dual screen LCD module.

The communication interface 205 may include one or more wired or wireless communication interfaces used to communicate with the media source 130 over the communication channels 112, 114, 116. For example, the communication interface 205 may include an Ethernet (e.g., 10Base-TO interface and/or a Wi-Fi interface (e.g., IEEE 802.11b/g)) for communication via the Internet, and a USB (Universal Serial Bus) interface, a serial interface, a parallel interface, and/or a Bluetooth interface for communication with the media source 130.

FIG. 2B illustrates the software modules of the electronic device, according to one embodiment of the present invention. The storage module 204 in the electronic devices 104, 114 includes, among other modules, a media application 254, an operating system (O/S) 258, a media file retriever 260, and the media file storage 118.

The media application 254 allows the user to access the media files stored in the media file storage 118. The media application 254 may be a program specifically designed for the electronic device 110. Alternatively, the media application 254 may be programs designed to operate across multiple types of electronic devices. Popular media applications include, among others, video and music players (e.g., Pocket Tunes, Kinoma, Windows Media Player, RealPlayer, iTunes, PowerDVD, QuickTime, and Winamp), web browsers (e.g., NetFront, Microsoft Internet Explorer, Mozilla Firefox, and Apple Safari), and image viewers (e.g., VD Image Viewer, and ADCSee). More than two media applications may be provided to access different types of media files on the electronic device 110.

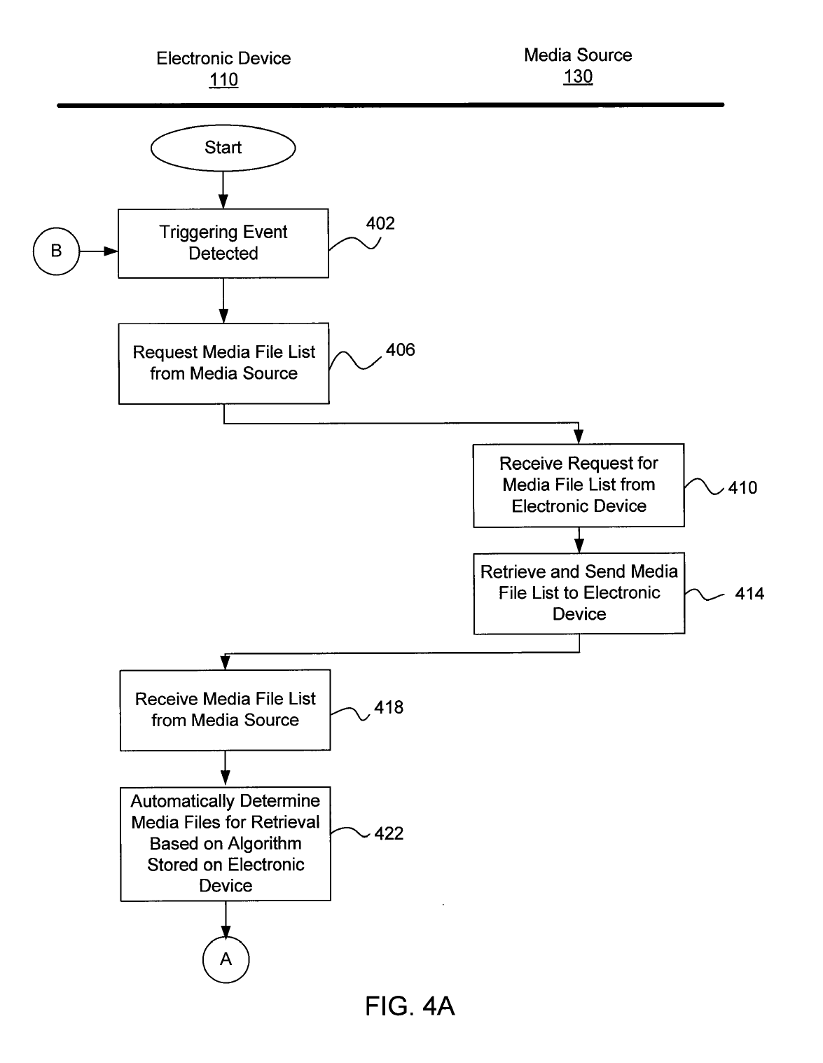

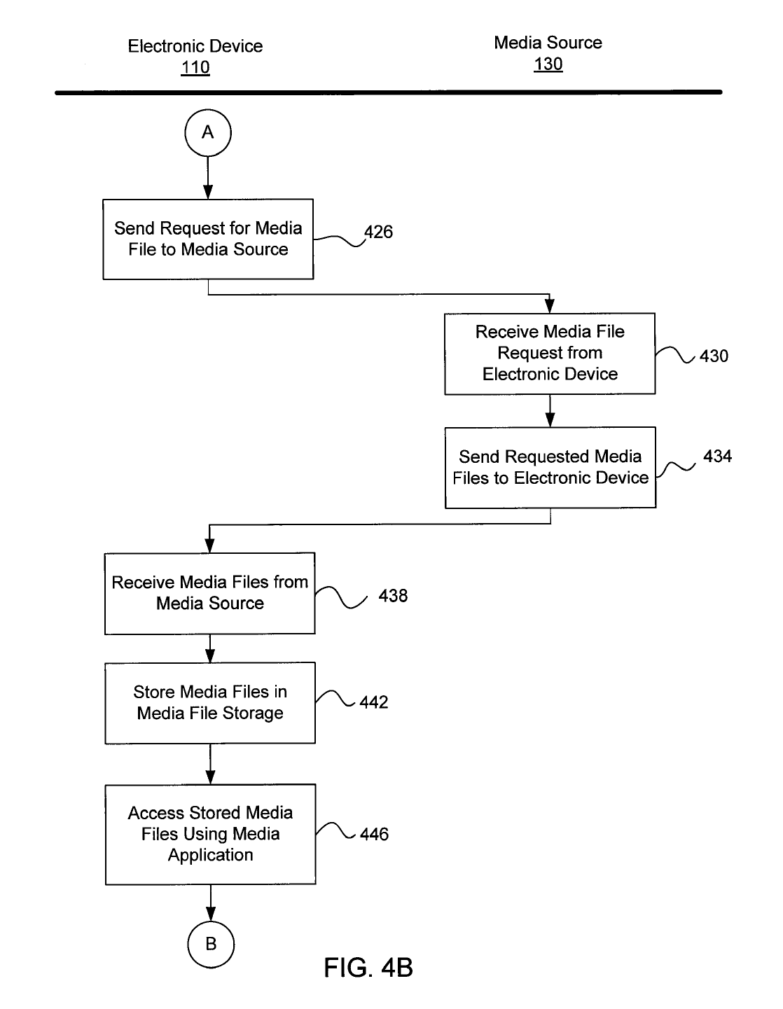

The media file retriever 260 operates in conjunction with the communication interface 205 to select and retrieve media files from the media source 130. Unlike conventional electronic devices that passively receive media files as selected by the user from the media source, the electronic device 110 according to the embodiments of the present invention automatically selects and retrieves the media files from the media source. Specifically, the media file retriever 260 of the electronic device 110 receives the list of the media files 134 from the media source 130 using an algorithm 230 that selects the media files to be retrieved based on the list of the media files 134, as described below in detail with reference to FIGS. 4A and 4B.

The list of media files 134 includes, among other information, the names or identities of media files stored in the media source 130. In one embodiment, the list of media files 134 includes time stamps indicating the time at which the media files were generated or added to the media source 130. By using the time stamps, the media file retriever 260 may implement a scheme that gives priority to the media files that were recently added to the media source 130. The users of the electronic devices generally prefer new media files over older media files. Therefore, by retrieving the recent media files, the users are more likely to find the most interesting media files on the electronic device 110. In still another embodiment, the list of media files 134 includes meta data that allow the media file retriever 260 to take into account the user's preferences in selecting the media files for retrieval.

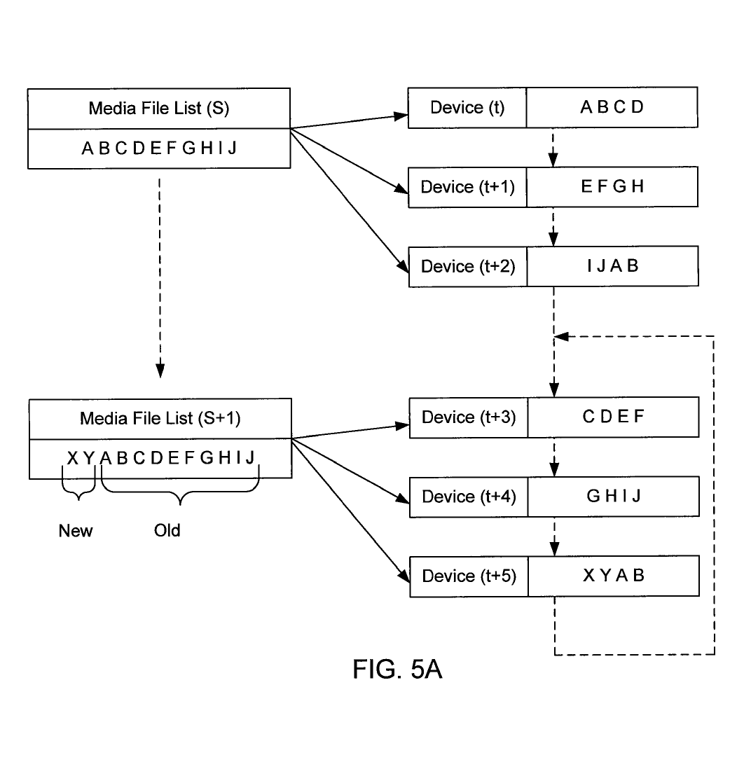

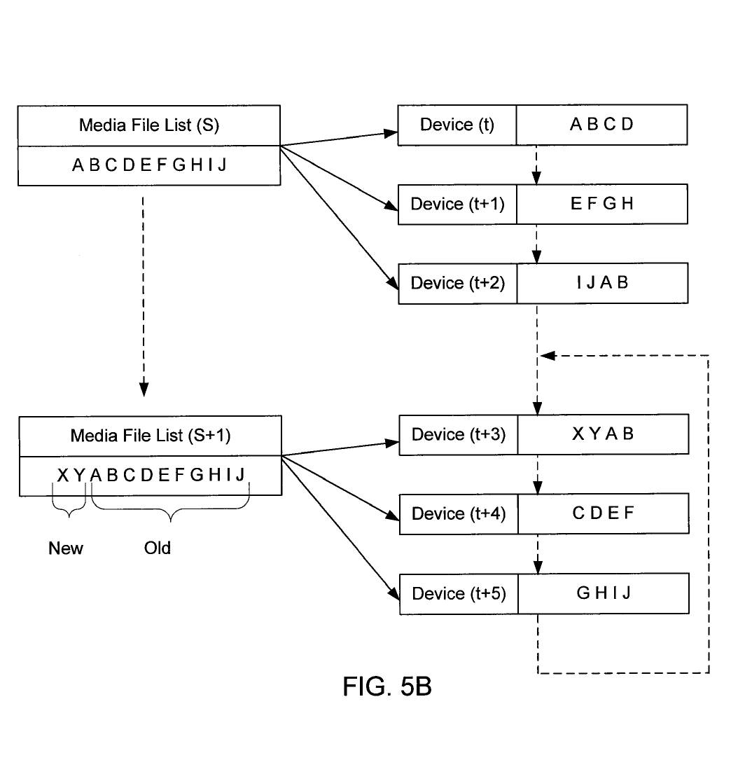

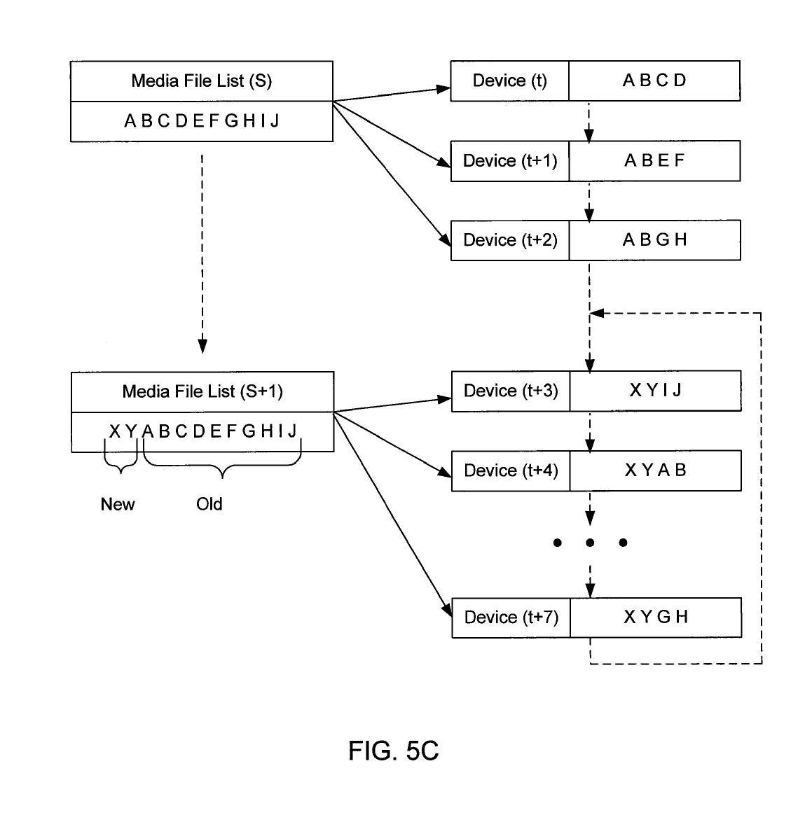

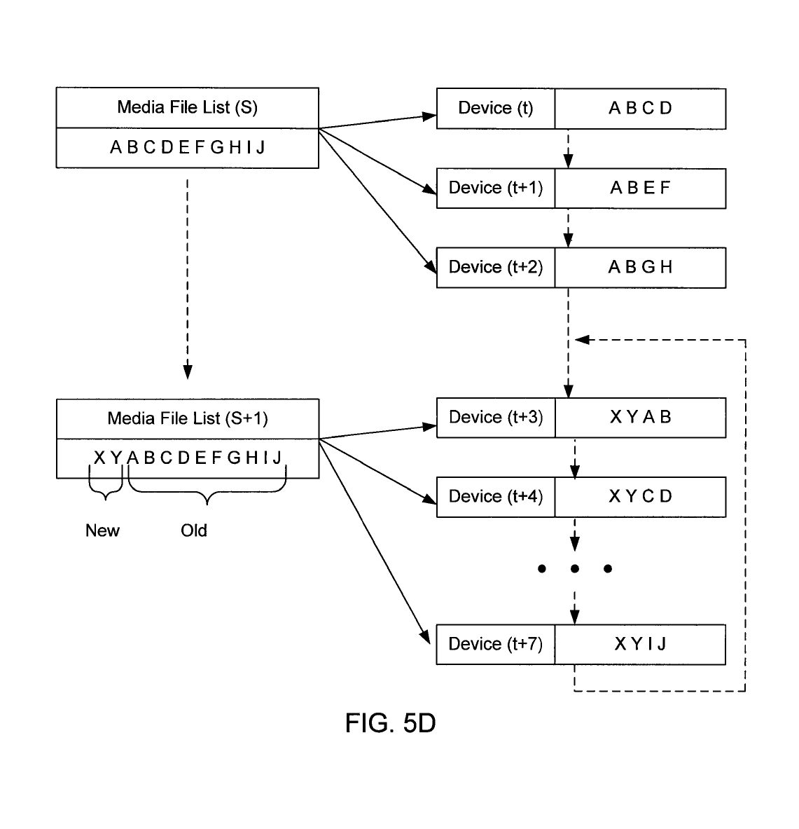

After receiving the list of the media files 134, the media files retriever 260 analyzes the list 134 and selects a subset of the media files to be retrieved from the media source 130 according to an updating scheme as implemented by the algorithm 230. As described below with reference to FIGS. 5A-5D, different updating schemes may be used to select the media files for retrieval from the media source 130.

By automatically selecting the media files to be retrieved, the user of the electronic device 110 is relieved of the task of manually selecting the media files to be transferred from the media source 130. Also, the user need not access the user interface of the media source 130 to update the media files to be retrieved by the electronic device 110. Further, because the electronic device 110 is responsible for selecting the media files for retrieval, the media source 130 need not include hardware or software components for selecting the media files for transfer to the electronic device 110.

In one embodiment, the media file retriever 260 includes a previous list 220 of media files retrieved from the media source 130 in previous communication sessions with the media source 130. The media file retriever 260 compares the previous list 220 with the list of media files 134 stored in the media source 130, and selects the media files to be updated in the next communication session. By using the previous list 220, the media file retriever 260 may avoid retrieving media files previously retrieved from the media source 130.

In one embodiment, the media file retriever 260 becomes operational upon detection of a triggering event. The triggering event may be one of various events including, among others, activation of the communication interface of the electronic device 110 or the media source 130, elapse of a predetermined amount of time, and a signal from the media source 130 indicating availability of new media files. In one embodiment, the triggering events are user-configurable. For example, the user can configure how frequent the media files should be updated (e.g., every day or every week).

The operating system module 258 manages the resources of the electronic device 110, and controls the operation of the electronic device 110.

FIG. 3A illustrates the hardware system of a media source 130, according to one embodiment of the present invention. In one embodiment, the media source 130 is a conventional server computer including a processor 302, a memory 303, a storage module (e.g., hard disk drive) 304, an input module (e.g., keyboard, mouse, and the like) 306, a display module 307, and a communication interface 305, exchanging data with one another through a bus 301. The communication interface 305 may include one or more wired or wireless communication modules used to communicate with the electronic device 110 over the communication channel 112, 114, 116. For example, the communication interface 205 may include an Ethernet (e.g., 10Base-TO interface and/or a Wi-Fi interface (e.g., IEEE 802.11b/g)) for communication via the Internet, and a USB (Universal Serial Bus) interface, a serial interface, a parallel interface, and/or a Bluetooth interface for communication with the electronic device locally.

The storage module 304 stores software that is run by the processor 302 in conjunction with the memory 303 to manage the exchange of data between the media source 130 and the electronic device 110. Operating system software and other application software may also be stored in the storage device 304 to run on the processor 302, as shown in FIG. 3B. Not all components of the media source 130 are shown in FIG. 3A and certain components not necessary for illustration of the present invention are omitted herein.

FIG. 3B illustrates the software modules of the media source 130, according to one embodiment of the present invention. The storage module 304 in the media source 130 includes, among other modules, the list of media files 134, the media file storage 138, an O/S module 354, and a media file manager 356.

The media file storage 138 stores a plurality of media files that are retrievable by the electronic device 110. In one embodiment, the media file storage 138 is implemented as a relational database adapted for storing one or more types of media files. As described above with reference to FIG. 1, the list of media files 134 is sent to the electronic device 110 upon request by the electronic device 110. In one embodiment, the storage capacity of the media file storage 138 of the media source 130 is greater than the storage capacity of the media file storage 118 of the electronic device 110.

The media file manager 356 generates and updates the list of media files 134. Specifically, whenever changes in the media files stored in the media file storage 138 occur, the media file manager 356 automatically updates the list of media files 134. The media file manager 356 sends the list of media files 134 to the electronic device 110 upon request from the electronic device 110.

Each component of the media source 130, whether alone or in combination with other components, can be implemented for example, in software, hardware, firmware or any other combination thereof.

FIGS. 4A and 4B are flowcharts illustrating a method for updating the media files stored in the electronic device, according to one embodiment of the present invention. A triggering event is first detected 402 at the electronic device 110. As described above with reference to FIG. 2B, the triggering event may include various events such as activation of a communication interface of the electronic device 110 or the media source 130, the elapse of a predetermined amount of time, or a signal from the media source indicating the updating of the files stored on the media source 130.

After the triggering event is detected, the electronic device 110 sends a request 406 to the media source 130 requesting the list of media files 134 via the communication interface 205. The media source 130 receives 410 the request for the list of the media files 134 via the communication interface 305. In response, the media source 130 retrieves and sends 414 the list of the media files 134 to the electronic device 110. Conventional communication protocols may be used to request the list 134 from the media source and to transfer the list 134 to the electronic device 110.

After receiving 418 the list of the media files 134, the media file retriever 260 of the electronic device 110 automatically determines 422 the media files to be retrieved from the media source 130 using an algorithm stored on the electronic device. The electronic device 110 may use various updating schemes to select the media files to be retrieved from the media source 130, as described below in detail with reference to FIGS. 5A to 5D.

After determining 422 the media files to be retrieved, the electronic device 110 sends 426 a request to the media source 130 to retrieve the selected media files via the communication interface 205. The requested media files include the media files as selected by the algorithm stored on the electronic device 110. The media source 130 receives 430 the request for the media files from the electronic device 110. In response, the media source 130 sends 434 the requested media files to the electronic device 110. Conventional communication protocols may be used to request the media files from the media source 130 and to transfer the selected media files to the electronic device 110. After receiving 438 the media files from the media source 130, the media files are stored 442 in the media file storage 118. The user may then access 446 the media files stored in the media file storage 118 using the media application 254.

In one or more embodiments, the algorithm 230 selects and retrieves in a first communication session a predetermined number of the media files starting from a starting media file. The starting media file is a media file in the list of the media files that shifts by the predetermined number in each communication session with the media source 130. In the second communication session, the starting media file shifts to a media file after the last media file selected and retrieved in the first communication session. The predetermined number (e.g., four) of files including the starting media file is selected and retrieved in the second communication session.

In one or more embodiments, the number of media files to be retrieved from the media source 130 is not predetermined but changed dynamically in each communication session depending on the size of the media files or the memory space available on the electronic device 110. For example, the number of files to be retrieved from the media source 130 may be set so that the total size of all the retrieved files does not exceed a threshold (e.g., 20 MB) or a predetermined portion (e.g., 50%) of the memory space available on the media file storage 118.

FIG. 5A is a diagram illustrating the electronic device 110 updated using an automatic updating scheme, according to such embodiments. The media file list (S) of FIG. 5A indicates ten (10) media files (i.e., media files A to J) stored in the media source 130. The media files in the list of media files of FIG. 5A are arranged in a sequence so that recently added media files appear before older media files. In a communication session at time (t), the electronic device 110 communicates with the media source 130 and receives a subset of media files A, B, C and D (the starting media file is media file A). In a subsequent communication session at time (t+1), the electronic device 110 deletes the previously received media files A, B, C, and D and updates its media file storage 118 with another subset of media files E, F, G, and H that were not retrieved in the previous communication session at time (t) (the starting media file is media file E). In the next communication session at time (t+2), the electronic device 110 retrieves a different subset of media files I, J, A and B (the starting media file is media file I). By updating the electronic device 110 with different subsets of media files (e.g., four files in the embodiment of FIG. 5A) on a rotating basis, the user may have opportunity to access different media files on the electronic device 110.

In a communication session at time (t+3) after media files X and Y are added to the media source 130 (as indicated by the media file list (S+1)), the electronic device 110 retrieves a subset of media files C, D, E, and F (the starting media file is media file C). In the media file list (S+1), the media files C, D, E, and F follow the subset of media files I, J, A and B that were retrieved in the previous communication session at time (t+2). In the updating scheme illustrated in FIG. 5A, no preferential treatment is given to the recently added media files X and Y. The electronic device 110 retrieves all the media files on a rotating basis until the end of the list 134 is reached at time (t+4). After reaching the end at time (t+4), the electronic device 120 retrieves recently added media files X and Y at time (t+5). Then the process returns to retrieving media files C, D, E, and F at the next communication session. The process is repeated according to the same updating sequence until new media files are again added to the media source 130.

FIG. 5B illustrates another updating scheme where the media files to be retrieved are reset and then rotated after adding the media files to the media source 130, according to one embodiment of the present invention. As in FIG. 5A, the media files in the list of media files of FIG. 5B are arranged in a sequence so that recently added media files appear before older media files. The sequence of updating the media files before addition of new media files X and Y to the media source 130 is the same as the scheme described above with reference to FIG. 5A. That is, in a communication session at time (t), the electronic device 110 communicates with the media source 130 and receives a subset of media files A, B, C and D. In a subsequent communication session at time (t+1), the electronic device 110 deletes the previously received media files A, B, C, and D and updates its media file storage 118 with another subset of media files E, F, G, and H that were not retrieved in the previous communication session at time (t). In the next communication session at time (t+2), the electronic device 110 retrieves a different subset of media files I, J, A and B.

After adding the new media files X and Y to the media source 130 (as indicated by media file list (S+1)), however, the starting media file is reset and the electronic device 110 retrieves recently added media files X and Y (along with media files A and B) in a communication session at time (t+3). Then the remaining media files C to J are retrieved by the electronic device 110 in the same manner as described above with reference to FIG. 5A. Specifically, in a communication session at time (t+3), the media files X, Y, A, and B are retrieved by the electronic device 110. In a subsequent communication session at (t+4), the media files C, D, E, and F are retrieved by the electronic device 110. Likewise, in a communication session at time (t+5), the media files G, H, I and J are retrieved by the electronic device 110.

The updating scheme of FIG. 5B gives priority to newly added media files X and Y by resetting the starting media file and the sequence of the media files to be retrieved so that newer media files are retrieved before the older media files. Then the process returns to retrieving media files X, Y, A, and B at the next communication session. The process is repeated until new media files are again added to the media source 130.

In one or more embodiments, the algorithm 230 splits the memory space of the media file storage 118 into two portions, one for the first number of media files and the other for the second number of media files. The two portions of memory space are managed separately by the algorithm 230. Specifically, the algorithm 230 selects and retrieves in a first communication session a first number of the media files that were recently added to the media source and a second number of media files starting from a starting media file excluding the recently added media files. The electronic device 110 in a second communication session subsequent to the first communication session retains the first number of media files but shifts the starting media file to a media file after a last media file in the second number of media files selected and retrieved in the first communication session.

FIG. 5C illustrates an updating scheme that maintains a certain number of the most recently added media files but rotates older media files, according to one embodiment. As in FIGS. 5A and 5B, the media files in the list of media files of FIG. 5C are arranged in a sequence so that recently added media files appear before older media files. In the example illustrated in FIG. 5C, the a first number (i.e., two) of the most recent media files (i.e., media files X and Y) are maintained in the electronic device 110 while a second number (i.e., two) of the other two media files are updated with older media files at each communication session. When media files A to J are available in the media source 130 (indicated by media file list (S)), media files are retained in the electronic device 110 because media files A and B are the two most recent files, but media files C to H are retrieved by the electronic device 110 on a rotating basis because media files C to H are older media files.

In a communication session at time (t), media files A, B, C, and D are selected and retrieved by the electronic device 110 (the starting media file is media file C). In a subsequent communication session at time (t+1), media files A and B are retained but media files C and D are updated with media files E and F (the starting media file is media file E). Likewise, in a communication session at time (t+2), media files A and B are retained but media files E and F are updated with media files G and H (the starting media file is media file G).

When two additional media files X and Y are added to the media source 130 (as indicated by media file list (S+1)), media files A and B are replaced with media files X and Y. The other two media files in the electronic device 110 are retrieved on a rotating basis. After adding the media files X and Y, the second number (i.e., two) of media files retrieved on a rotating basis now include media files A and B because media files A and B are treated as older files.

Thus, in a communication session at time (t+3), all four media files are updated (media files A, B, G and H are updated with media files X, Y, I and J). In a communication session at time (t+4), the media files X and Y are treated as new and retained in the electronic device 110 whereas media files I and J are updated with media files A, B. In each communication session, the starting media file is shifted by two media files. The process is repeated until all the older media files are retrieved in a communication session at time (t+8). After rotating the last subset of older media files I and J in communication session at time (t+8), the starting media file is reset and the process returns to retrieving media files A and B in the next communication session. The process is repeated until new media files are again added to the media source 130.

FIG. 5D illustrates another updating scheme that maintains the most recently added media files but rotates older media files, according to one embodiment of the present invention. The scheme illustrated in FIG. 5D is the same as the scheme of FIG. 5C except that the starting media file is reset in a communication session (t+3) after new media files X and Y are added to the media source 130. Specifically, after the media files X and Y are added to the media source 130, the electronic device 110 maintains the added media files X and Y in its media file storage 118 but retrieves older media files starting with the most recent media files (i.e., media files A and B). The updating scheme of FIG. 5D prioritizes media files A and B against other older media files C to J by retrieving media files A and B before other older media files C to J.

The updating schemes of FIGS. 5C and 5D maintains a predetermined number or portion of the most recent media files in the electronic device 110 while updating other media files at each communication session with the media source on a rotating basis. Therefore, in the embodiments of FIGS. 5C and 5D, the user may always access a subset of the most recent media files (e.g., media files X and Y) together with a mix of older media files (e.g., media files A to J).

The updating schemes of FIGS. 5A to 5D are merely illustrative, and other updating schemes may also be used. In one embodiment, the electronic device 110 randomly selects the media files to be retrieved from the media source 130. In another embodiment, user preferences may be stored on the electronic device 110 to update the media files that are likely to be of interest to the user. The list of media files 134 may include metadata of the media files to prioritize the media files based on the user preferences.

In one embodiment, the user may select the updating scheme to be used by the electronic device 110. The user may input preference on the updating scheme using the input module 206 provided on the electronic device 110.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Upon reading this disclosure, those of ordinary skill in the art will appreciate still additional alternative structural and functional designs for selecting and retrieving the media files at the electronic devices through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those in the art may be made in the arrangement, operations and details of the method and apparatus of the present invention disclosed herein without departing from the spirit and scope of the invention as defined in the appended claims.

What is claimed is:

1. An electronic device for accessing media files stored on a media source, comprising:
a communication interface for communicating with the media source;
a media file retriever coupled to the communication interface to retrieve a subset of the media files from the media source, the media file retriever comprising codes for executing an algorithm that automatically selects the subset of the media files based on a list of the media files received from the media source, the list of the media files indicative of the media files stored in the media source;
media file storage associated with the communication interface, the media file storage storing the subset of the media files as retrieved by the media file retriever; and
a media application associated with the media file storage for accessing the subset of the media files stored on the media file storage.

2. The electronic device of claim 1, wherein the media file retriever updates the subset of the media files in each communication session between the electronic device and the media source.

3. The electronic device of claim 2, wherein the media file retriever maintains a history of the subset of the media files retrieved in a first communication session to select and retrieve in a second communication session subsequent to the first communication session the subset of the media files not retrieved in the first communication session.

4. The electronic device of claim 1, wherein the algorithm selects and retrieves in a first communication session a predetermined number of the media files starting from a starting media file as listed in the list of the media files, and the starting media file shifted to a media file after a last media file in the list selected and retrieved in the first communication session to retrieve the predetermined number of media files starting from the shifted starting media file in a second communication session subsequent to the first communication session.

5. The electronic device of claim 4, wherein the list of the media files prioritizes the media files in an order that the media files were added to the media source, and the starting media file returning to the first media file listed in the list of media files responsive to changes in the media files stored in the media source.

6. The electronic device of claim 1, wherein the algorithm selects and retrieves in a first communication session a first number of the media files that were recently added to the media source and a second number of media files starting from a starting media file excluding the recently added media files, and the algorithm in a second communication session subsequent to the first communication session retaining the first number of media files but shifting the starting media file for the second number of media to a media file after a last media file in the second number of media files selected and retrieved in the first communication session.

7. The electronic device of claim 6, wherein the list of the media files prioritizes the media files in an order that the media files were added to the media source, and the starting media file returning to a first media file listed after the recently added media files in the list of media files responsive to changes in the media files stored in the media source.

8. The electronic device of claim 1, wherein the media file retriever comprises codes for multiple algorithms for selecting and retrieving the media file.

9. A method for using an electronic device to access media files stored in a media source, the method comprising:
communicating between the electronic device and the media source;
the electronic device selecting and retrieving a subset of the media files stored in the media source, the subset of the media files selected automatically by an algorithm executed on an electronic device based on a list of the media files received from the media source, the list of the media files indicative of the media files stored in the media source;
storing the subset of the media files as selected by the media file retriever on the electronic device; and
accessing the subset of the media files stored in the electronic device.

10. The method of claim 9, further comprising the electronic device updating the subset of the media files in each communication session with the media source.

11. The method of claim 10, wherein retrieving the subset of the media files comprises maintaining a history of the media files selected in a first communication session between the electronic device and the media source to select the subset of the media files for retrieval in a second communication session subsequent to the first communication session.

12. The method of claim 10, wherein the algorithm selects and retrieves in a first communication session a predetermined number of the media files starting from a starting media file as listed in the list of the media files, and the starting media file shifted to a media file after a last media file in the list selected and retrieved in the first communication session to retrieve the predetermined number of media files starting from the shifted starting media file in a second communication session subsequent to the first communication session.

13. The method of claim 12, wherein the list of the media files prioritizes the media files in an order that the media files were added to the media source, and the starting media file returning to the first media file listed in the list of media files responsive to changes in the media files stored in the media source.

14. The method of claim 10, wherein the algorithm selects and retrieves in a first communication session a first number of the media files that were recently added to the media source and a second number of media files starting from a starting media file excluding the recently added media files, and the algorithm in a second communication session subsequent to the first communication session retaining the first number of media files but shifting the starting media file for the second number of media to a media file after a last media file in the second number of media files selected and retrieved in the first communication session.

15. The method of claim 14, wherein the list of the media files prioritizes the media files in an order that the media files were added to the media source, and the starting media file returning to a first media file listed after the recently added media files in the list of media files responsive to changes in the media files stored in the media source.

16. The method of claim 9, further comprising receiving a user input for selecting the algorithm to be used for selecting and retrieving the subset of the media files.

17. A computer program product stored in a computer readable storage medium for accessing at an electronic device media files stored in a media source, the computer readable storage medium structured to store instructions executable by a processor in the electronic device, the instructions, when executed cause the processor to:
communicate between the electronic device and the media source;
select and retrieve a subset of the media files stored in the media source, the subset of the media files selected automatically by an algorithm executed on an electronic device based on a list of the media files received from the media source, the list of the media files indicative of the media files stored in the media source;
store the subset of the media files on the electronic device; and
access the subset of the media files stored in the electronic device.

18. The computer program product of claim 17, further comprising instructions to update the selected subset of the media files in each communication session with the media source.

19. The computer program product of claim 17, wherein the algorithm selects and retrieves in a first communication session a predetermined number of the media files starting from a starting media file as listed in the list of the media files, and the starting media file shifted to a media file after a last media file in the list selected and retrieved in the first communication session to retrieve the predetermined number of media files starting from the shifted starting media file in a second communication session subsequent to the first communication session.

20. The computer program product of claim 17, wherein the algorithm selects and retrieves in a first communication session a first number of the media files that were recently added to the media source and a second number of media files starting from a starting media file excluding the recent added media files, and the algorithm in a second communication session subsequent to the first communication session retaining the first number of media files but shifting the starting media file for the second number of media to a media file after a last media file in the second number of media files selected and retrieved in the first communication session.
